(19) United States
(12) Patent Application Publication
(10) Pub. No.: US 2026/0323731 A1
(43) Pub. Date: Oct. 15, 2026

(54) DEVICE AND METHOD FOR TRANSMITTING AND RECEIVING NOMA SIGNAL ON BASIS OF RIS CONTROL IN WIRELESS COMMUNICATION SYSTEM

(71) Applicant: LG ELECTRONICS INC., Seoul (KR)

(72) Inventors: Donghwan KIM, Seoul (KR); Jihwan JANG, Seoul (KR); Jaeky OH, Seoul (KR); Jaehoon CHUNG, Seoul (KR); Seungwoo RYU, Seoul (KR)

(73) Assignee: LG ELECTRONICS INC., Seoul (KR)

(21) Appl. No.: 19/485,458

(22) PCT Filed: May 24, 2023
(86) PCT No.: PCT/KR2023/007079

§ 371 Date: Nov. 18, 2025

(51) Int. Cl. H04W 76/10; H04B 7/04; H04B 7/06; H04B 17/309; H04W 72/044; H04W 76/20

(52) U.S. Cl. CPC H04W 76/10; H04B 7/04013; H04B 7/0626; H04B 17/346; H04W 72/0473; H04W 76/20

(57) ABSTRACT

The objective of the present disclosure is to transmit a sequentially superimposed signal utilizing non orthogonal multiple access (NOMA) technology via a communication channel using reconfigurable intelligent surface (RIS) in a wireless communication system, and the operation method of a base station may comprise the steps of: establishing an RRC connection with a first device; receiving a plurality of channel state information on the basis of the RRC connection; determining a communication channel on the basis of the plurality of measured channel state information; determining a power allocation coefficient of terminals on the basis of the communication channel; and transmitting a signal on the basis of the power allocation coefficient.

### CROSS-REFERENCE TO RELATED APPLICATIONS

This application is the National Stage filing under 35 U.S.C. 371 of International Application No. PCT/KR2023/007079, filed on May 24, 2023, the contents of which are all hereby incorporated by reference herein in their entireties.

### TECHNICAL FIELD

The following description relates to a wireless communication system, including a method for transmitting and receiving anon orthogonal multiple access (NOMA) signal based on reconfigurable intelligent surface (RIS) control in the wireless communication system, and a device supporting the same.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure may provide a method for transmitting and receiving a non orthogonal multiple access (NOMA) signal based on reconfigurable intelligent surface (RIS) control in a wireless communication system, and a device supporting the same.

The present disclosure may provide a method for determining an RIS channel to be used for signal transmission and reception in a wireless communication system, and a device supporting the same.

The present disclosure may provide a method for determining an RIS user group in a wireless communication system, and a device supporting the same.

The present disclosure may provide a method for performing RIS channel reselection in a wireless communication system, and a device supporting the same.

The present disclosure may provide a method for performing RRC connection with an RIS controller in a wireless communication system, and a device supporting the same.

The present disclosure may provide a method for improving a channel gain of a UE by using an RIS channel in a wireless communication system, and a device supporting the same.

The present disclosure may provide a method for performing power allocation based on a variance of channel gains in a wireless communication system, and a device supporting the same.

The present disclosure may provide a method for performing power allocation based on a channel reselection object in a wireless communication system, and a device supporting the same.

The present disclosure may provide a method for transmitting a NOMA signal through an RIS channel in a wireless communication system, and a device supporting the same.

The present disclosure may provide a method for performing power allocation based on minimum power allocation and remaining power distribution based on a channel gain in a wireless communication system, and a device supporting the same.

The present disclosure may provide a method for determining a reference UE based on a variance of channel gains and performing power allocation based on the reference UE in a wireless communication system, and a device supporting the same.

The present disclosure relates to a method for transmitting a plurality of transport blocks (TBs) as a single unit in a wireless communication system, and a device supporting the same.

The technical objects to be achieved in the present disclosure are not limited to the above-mentioned technical objects, and other technical objects that are not mentioned may be considered by those skilled in the art through the embodiments described below.

As an example of the present disclosure, provided is a method by a base station in a wireless communication system. The method may comprise: establishing an RRC connection with a first device; receiving a plurality of channel state information based on the RRC connection; determining a communication channel based on the plurality of measured channel state information; determining power allocation coefficients of user equipments (UEs) based on the communication channel; and transmitting a signal based on the power allocation coefficients, wherein establishing the RRC connection comprises: receiving reflection pattern information that is changeable through reconfigurable intelligent surface (RIS) control by the first device, and the signal may be transmitted to the UEs through an RIS channel after being generated by superposition coding.

As an example of the present disclosure, provided is a method by a UE in a wireless communication system. The method may comprise: receiving a reference signal from a base station; transmitting channel state information based on the reference signal; receiving a channel reselection object from the base station; transmitting a channel reselection request message based on the channel reselection object; and receiving a signal generated by superposition coding from the base station through an RIS channel, wherein the channel reselection object may include at least one of a threshold for channel reselection and a channel gain of a channel not using an RIS.

As an example of the present disclosure, provided is a base station in a wireless communication system. The base station may comprise: a transceiver; and a processor connected to the transceiver, wherein the processor is configured to: establish an RRC connection with a first device; receive a plurality of channel state information based on the RRC connection; determine a communication channel based on the plurality of measured channel state information; determine power allocation coefficients of UEs based on the communication channel; and transmit a signal based on the power allocation coefficients, wherein establishing the RRC connection comprises: receiving reflection pattern information that is changeable through reconfigurable intelligent surface (RIS) control by the first device, and the signal may be transmitted to the UEs through an RIS channel after being generated by superposition coding.

As an example of the present disclosure, provided is a UE in a wireless communication system. The UE may comprise: a transceiver, and a processor connected to the transceiver, wherein the processor is configured to: receive a reference signal from a base station; transmit channel state information based on the reference signal; receive a channel reselection object from the base station; transmit a channel reselection request message based on the channel reselection object; and receive a signal generated by superposition coding from the base station through an RIS channel, wherein the channel reselection object may include at least one of a threshold for channel reselection and a channel gain of a channel not using an RIS.

As an example of the present disclosure, provided is a communication device. The communication device may comprise: at least one processor; at least one computer memory connected to the at least one processor and storing instructions for instructing operations based on being executed by the at least one processor, wherein the operations comprise: establishing an RRC connection with a first device; receiving a plurality of channel state information based on the RRC connection; determining a communication channel based on the plurality of measured channel state information; determining power allocation coefficients of UEs based on the communication channel; and transmitting a signal based on the power allocation coefficients, wherein establishing the RRC connection comprises: receiving reflection pattern information that is changeable through reconfigurable intelligent surface (RIS) control by the first device, and the signal may be transmitted to the UEs through an RIS channel after being generated by superposition coding.

As an example of the present disclosure, provided is a non-transitory computer-readable medium storing at least one instruction. The non-transitory computer-readable medium may comprise: the at least one instruction executable by a processor, wherein the at least one instruction controls a device to: establish an RRC connection with a first device; receive a plurality of channel state information based on the RRC connection; determine a communication channel based on the plurality of measured channel state information; determine power allocation coefficients of UEs based on the communication channel; and transmit a signal based on the power allocation coefficients, wherein establishing the RRC connection comprises: receiving reflection pattern information that is changeable through reconfigurable intelligent surface (RIS) control by the first device, and the signal may be transmitted to the UEs through an RIS channel after being generated by superposition coding.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

Based on the present disclosure, a non-orthogonal multiple access (NOMA) signal can be effectively transmitted and received based on reconfigurable intelligent surface (RIS) control.

It will be appreciated by persons skilled in the art that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system applicable to the present disclosure.

FIG. 2 shows an example of a wireless device applicable to the present disclosure.

FIG. 3 shows another example of a wireless device applicable to the present disclosure.

FIG. 4 shows an example of a hand-held device applicable to the present disclosure.

FIG. 5 shows an example of a car or an autonomous driving car applicable to the present disclosure.

FIG. 6 shows an example of artificial intelligence (AI) device applicable to the present disclosure.

FIG. 7 shows a method of processing a transmitted signal applicable to the present disclosure.

FIG. 8 shows an example of a communication structure providable in a 6G system applicable to the present disclosure.

FIG. 9 shows an electromagnetic spectrum applicable to the present disclosure.

FIG. 10 shows a THz communication method applicable to the present disclosure.

FIG. 11 shows a wireless channel environment based on an embodiment of the present disclosure.

FIG. 12 shows an intelligent wireless environment based on an embodiment of the present disclosure.

FIG. 13 shows a downlink communication environment between a base station at a transmission side and two UEs at a reception side in a NOMA system based on an embodiment of the present disclosure.

FIG. 14 shows a process for superposing a signal X.

FIG. 15 shows a process for extracting signals S₁ and S₂ by a first UE and a second UE, respectively, in the NOMA system communication environment of FIG. 13, based on an embodiment of the present disclosure.

FIG. 16 shows an environment for transmitting a signal to a UE located in a shadow area by using a beam utilizing an RIS through control of elements of the RIS at a base station, based on an embodiment of the present disclosure.

FIG. 17 shows a procedure for transmitting a signal to a plurality of UEs by using an RIS at a base station based on an embodiment of the present disclosure.

FIG. 18 shows an example of a procedure for establishing a connection with an RIS through an RRC connection at a base station based on an embodiment of the present disclosure.

FIG. 19 shows a procedure for applying beamforming at a base station based on an embodiment of the present disclosure.

FIG. 20 shows a procedure for applying beamforming in consideration of an RIS channel based on an embodiment of the present disclosure.

FIG. 21 shows an example of a signal flow between a base station, an RIS controller, an RIS and UEs for measuring RIS channel state information based on an embodiment of the present disclosure.

FIG. 22 shows an example of a procedure for determining an RIS channel at a base station based on an embodiment of the present disclosure.

FIG. 23 shows a channel gain of a UE that are changed based on a change of an RIS channel.

FIG. 24 shows an example of a signal flow for measuring an RIS channel gain and determining a reflection pattern at a base station based on an embodiment of the present disclosure.

FIG. 25 shows a situation for triggering an RIS channel reselection request.

FIG. 26 shows an example of a signal flow between a base station, an RIS controller and UEs for obtaining channel information and reselecting an RIS channel based on an embodiment of the present disclosure.

FIG. 27 shows an operation procedure for performing NOMA communication at a UE based on an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiments of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

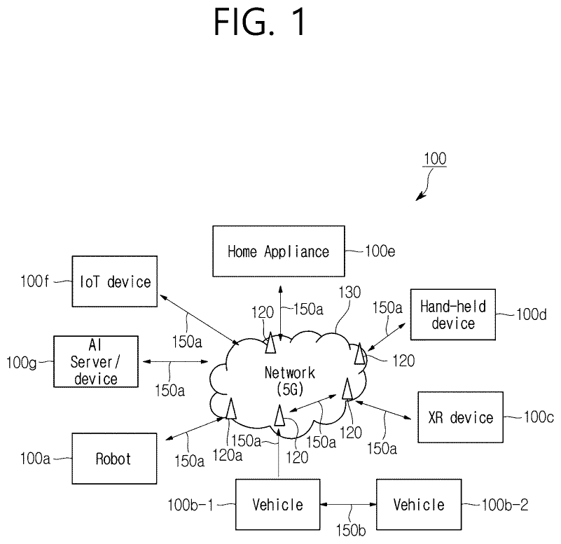

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

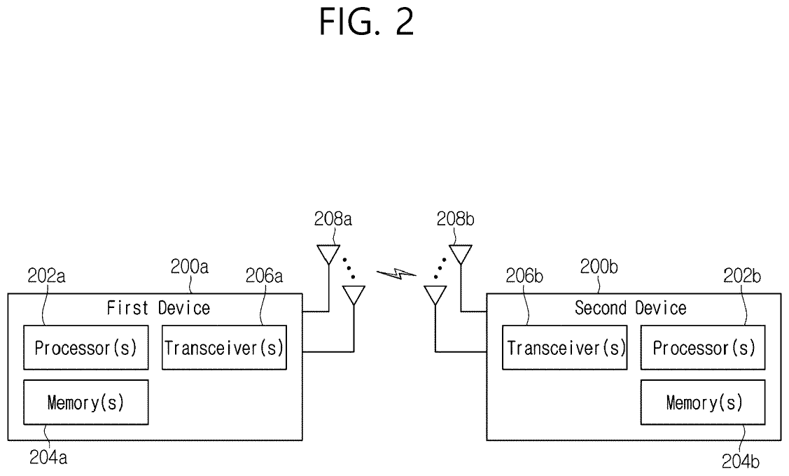

FIG. 2 shows an example of a wireless device applicable to the present disclosure.

Referring to FIG. 2, a first wireless device 200a and a second wireless device 200b may transmit and receive radio signals through various radio access technologies (e.g., LTE or NR). Here, (the first wireless device 200a, the second wireless device 200b) may correspond to (the wireless device 100x, the base station 120) and/or (the wireless device 100x, the wireless device 100x) of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as physical (PHY), media access control (MAC), radio link control (RLC), packet data convergence protocol (PDCP), radio resource control (RRC), service data adaptation protocol (SDAP)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

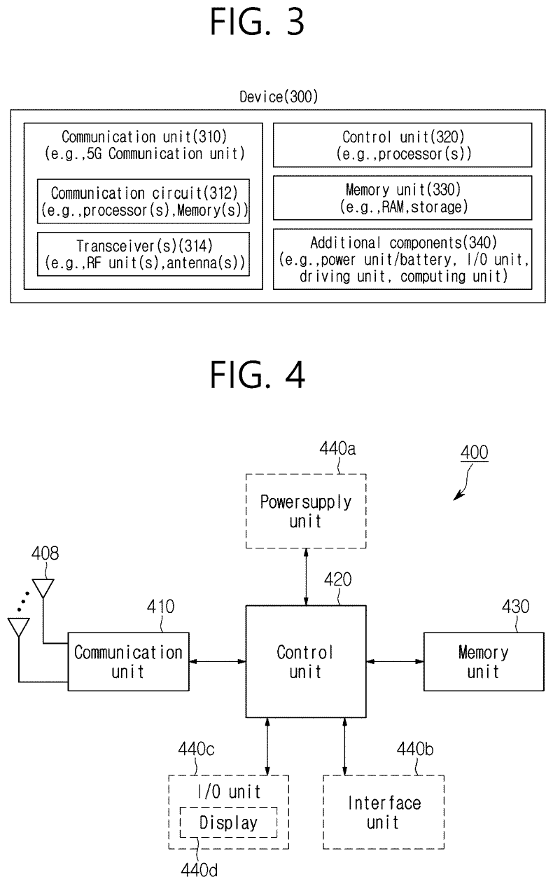

FIG. 3 shows another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 shows an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440 d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

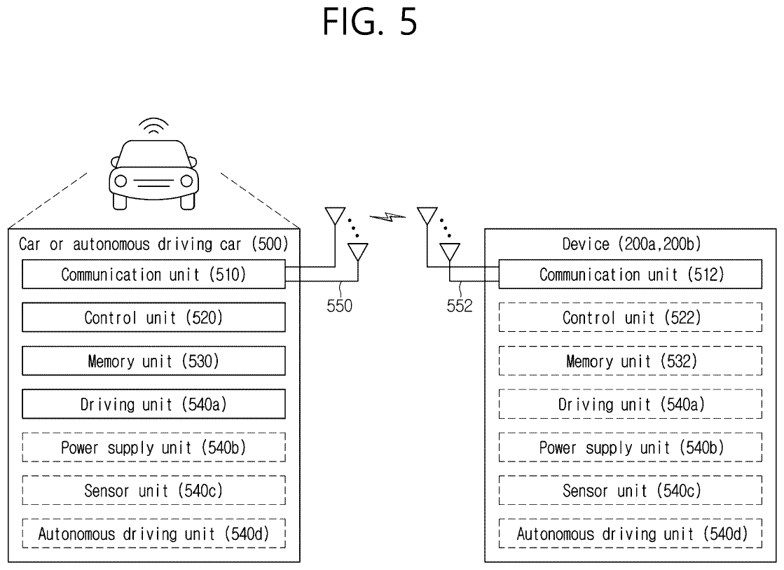

FIG. 5 shows an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

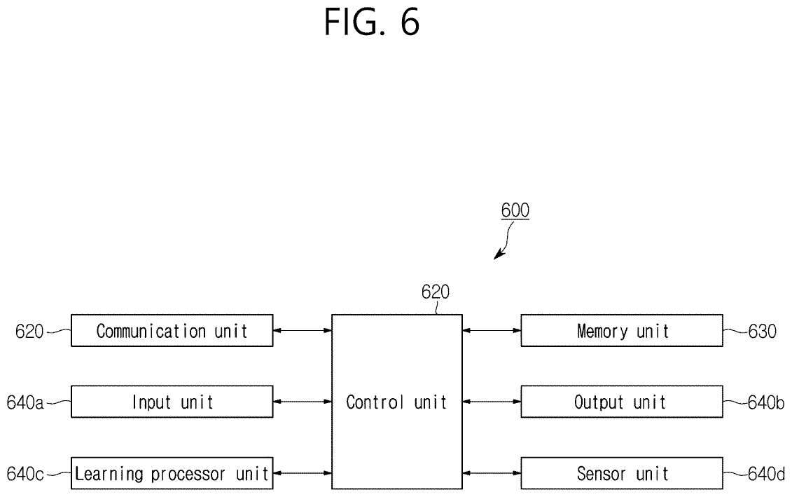

FIG. 6 shows an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640a/640b, a leaning processor unit (learning processor) 640c and a sensor unit 640d. The blocks 610 to 630/640a to 640d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640c or transmit the history information to the AI server (FIG. 1, 140). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensing unit 640. In addition, the memory unit 630 may store control information and/or software code necessary to operate/execute the control unit 620.

The input unit 640a may acquire various types of data from the outside of the AI device 600. For example, the input unit 640a may acquire learning data for model learning, input data, to which the learning model will be applied, etc. The input unit 640a may include a camera, a microphone and/or a user input unit. The output unit 640b may generate video, audio or tactile output. The output unit 640b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640c may train a model composed of an artificial neural network using training data. The learning processor unit 640c may perform AI processing along with the learning processor unit of the AI server (FIG. 1, 140). The learning processor unit 640c may process information received from an external device through the communication unit 610 and/or information stored in the memory unit 630. In addition, the output value of the learning processor unit 640c may be transmitted to the external device through the communication unit 610 and/or stored in the memory unit 630.

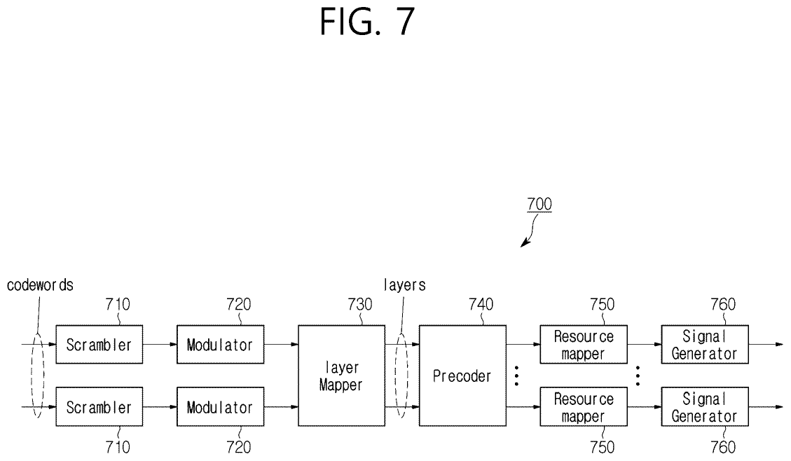

FIG. 7 shows a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 710 to 760 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |
| Mobility support | Up to 1000 | km/hr |

| | |
|---|---|
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

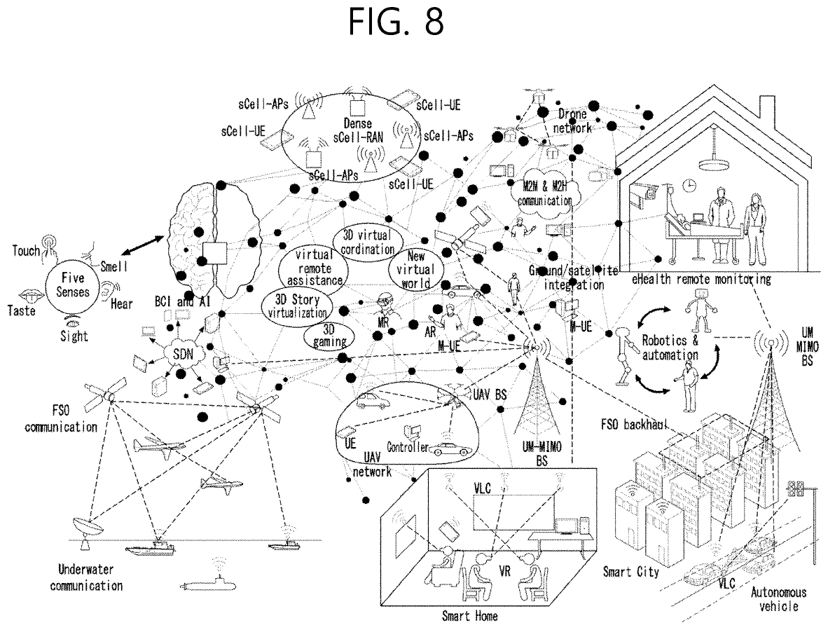

FIG. 8 shows an example of a communication structure providable in a 6G system applicable to the present disclosure.

Referring to FIG. 8, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to create a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

### Terahertz (THz) Communication

THz communication is applicable to the 6G system. For example, a data rate may increase by increasing bandwidth. This may be performed by using sub-THz communication with wide bandwidth and applying advanced massive MIMO technology.

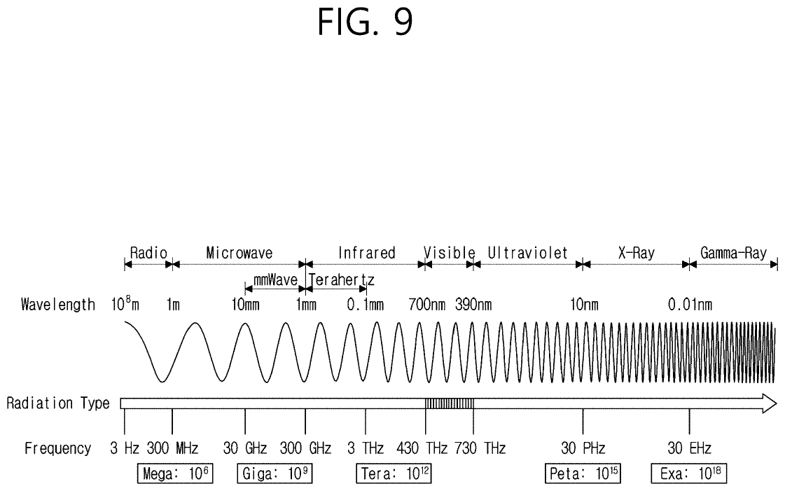

FIG. 9 shows an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and a BS operating in this band. Therefore, an advanced adaptive arrangement technology capable of overcoming a range limitation may be used.

### Terahertz (THz) Wireless Communication

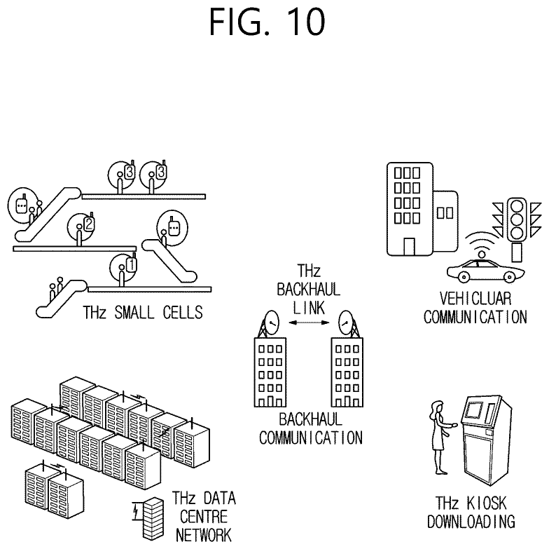

FIG. 10 shows a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Specific Embodiment of the Present Disclosure

Hereinafter, a power allocation method of non orthogonal multiple access (NOMA) using a reconfigurable intelligent surface (RIS) may be presented to increase channel capacity available to a UE. In current wireless communication technology, multiple access technology affects system performance. Multiple access technology may be classified into orthogonal and non orthogonal methods. In LTE, 5G, orthogonal frequency division multiple access (OFDMA), which is an orthogonal multiple access (OMA) method, has been adopted and is being used. However, due to the demand for higher system efficiency, NOMA technology has been studied. NOMA technology may achieve higher spectral efficiency than existing OMA technology by applying superposition coding at a transmission side and applying successive interference cancellation (SIC) at a reception side.

NOMA technology enables the use of the entire frequency bandwidth for all users through a superposition coding technique at a transmission side and a successive interference cancellation technique at a reception side. At this time, the transmission side needs to have channel information such as channel state information (SCI), etc. The transmission side may superpose and transmit data by allocating total power to each user based on the channel information. The transmission side allocates higher power to a user having a low channel gain, such as a cell edge user, and allocates lower power to a user located in a cell center area based on the channel information. A user that has received data first decodes a signal having a power larger than its own signal power and removes it from a total received signal by performing successive interference cancellation. Each user repeats this operation until decoding its own signal. Through this method, NOMA technology may have better frequency efficiency than OMA technology.

However, in NOMA technology, due to non-uniform wireless channel characteristics between a transmission side and multiple reception sides, an increase in data transmission rate through maximization of frequency efficiency causes degradation of fairness in user data transmission rates. A user having a poor channel state may not be properly allocated power compared to a user having a good channel state, which may deteriorate transmission speed and signal strength. In addition, if there are many users having poor channel states, a large amount of power is allocated to the users having poor channel states, which may deteriorate quality of service of all users. Therefore, a scheme for allocating appropriate power to each user is needed. A communication scheme using an RIS may increase total channel gain and allow each user to experience better transmission speed and signal strength by allocating appropriate power to each user.

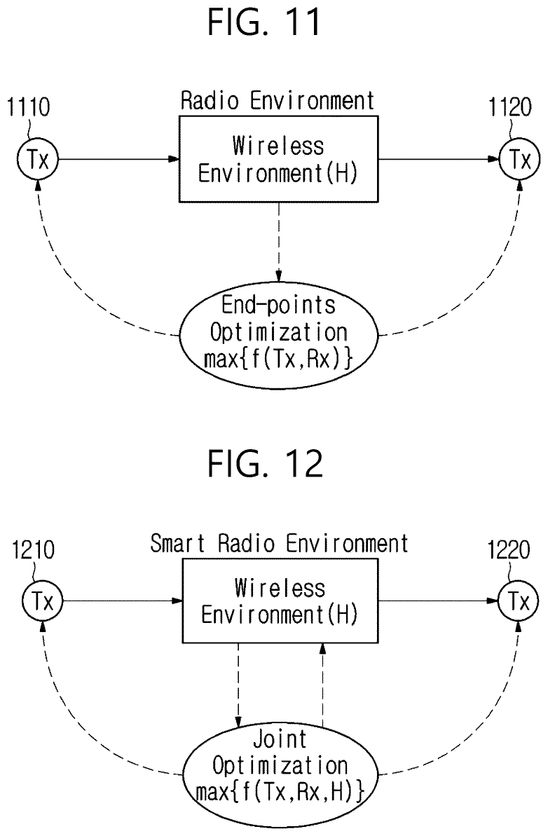

FIG. 11 shows a wireless channel environment based on an embodiment of the present disclosure. Referring to FIG. 11, in an existing communication system, a wireless channel environment (H) is naturally fixed and may be an uncontrollable random state. Accordingly, a transmitter 1110 and a receiver 1120 may find an optimized transmission and reception method by adapting to the channel. The transmitter 1110 and the receiver 1120 may measure a channel state through a signal (e.g., a reference signal) and may be controlled to perform optimization based on the measured channel state. However, as described above, in environments such as a terahertz environment in which signal loss is large and multipath application is difficult and in NLOS environments such as shadow areas, there may be a limitation in data transmission. For example, [Equation 1] below may represent capacity limit of Shannon. At this time, even if precoding and processing are applied to a transmission signal P in [Equation 1] to increase it, if a size of channel |H| is small, there may be a limitation in increasing channel capacity.

In a state in which a wireless channel environment is fixed, there may be a limitation in increasing channel capacity based on [Equation 1]. At this time, communication using an RIS may secure a multipath between a transmitter 1110 and a receiver 1120 and may increase the above-described channel |H|. That is, in a smart radio environment, a wireless channel environment may be a controllable factor based on the RIS, and channel capacity may be increased through this.

$$C = log ( 1 + \frac{{\vert HP \vert}^{2}}{{σ}^{2}} ) \qquad [ Equation 1 ]$$

For example, FIG. 12 shows an intelligent wireless environment based on an embodiment of the present disclosure. Referring to FIG. 12, in an intelligent wireless channel environment, a wireless channel |HI may be a factor for optimization. More specifically, in FIG. 11 described above, optimization may be performed at a transmitter 1110 and a receiver 1120 based on “max{f(Tx, Rx)}” as endpoint optimization, as described above. However, in FIG. 12, optimization may be performed at a transmitter 1210 and a receiver 1220 based on “max{f(Tx, Rx, H)}” as endpoint optimization. That is, in an intelligent wireless environment, a channel may be used as a factor for optimization based on an intelligent reflecting surface.

In consideration of the above, in a new communication system, communication may be performed based on an intelligent wireless environment. At this time, in the intelligent wireless environment, parameters related to an RIS may be used as factors capable of controlling a wireless channel, like a transmitter and a receiver.

That is, a factor for a wireless channel using an RIS may be additionally used as a factor for optimizing wireless communication transmission. Through this, previously unsolvable problems such as channel resetting or channel capacity limit of Shannon may be overcome. However, since additional measurement of the channel using the RIS in an intelligent wireless environment is required and optimization considering the RIS together with a transmitter and a receiver is needed, the optimization process may become complicated accordingly.

To efficiently use an RIS, a reference signal for measuring channel state information may be used to measure a wireless channel environment. At this time, the channel state information is a term collectively referring to information that may represent wireless environment quality between a UE and a base station antenna, and is not necessarily limited to information on channel gain. A base station may transmit a reference signal to a UE to measure a wireless channel environment of a downlink toward the UE, and may receive a measurement result of the channel state information based on the reference signal from the UE. The reference signal is not limited to a specific signal, and may include at least one of a cell-specific reference signal (CRS), a UE-specific reference signal (UE-RS), a demodulation reference signal (DM-RS), a channel state information reference signal (CSI-RS), an MBSFN reference signal, a positioning reference signal (PRS), a phase tracking reference signal (PTRS), etc.

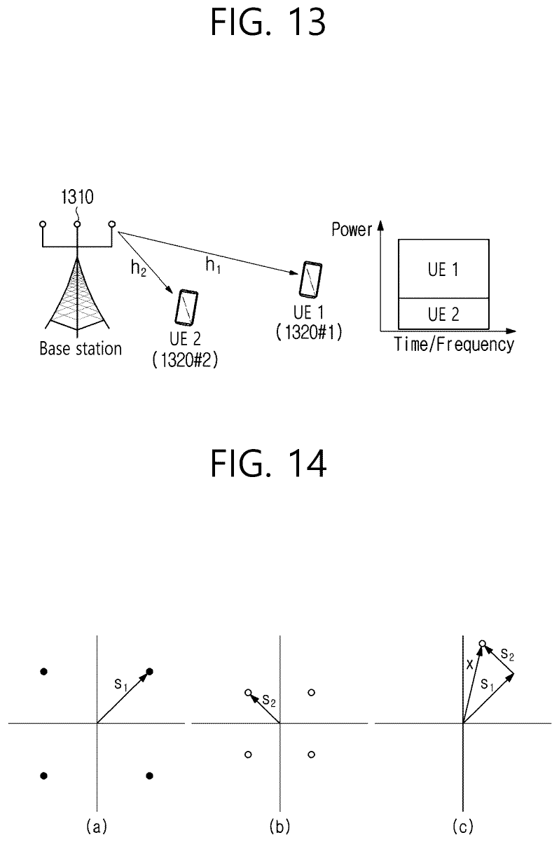

FIG. 13 shows a downlink communication environment between a base station 1310 at a transmission side and two UEs 1320 #1 to 1320 #2 at a reception side in a NOMA system based on an embodiment of the present disclosure. NOMA technology, in order to maximize frequency efficiency, allows the base station 1310 to allocate different powers to a plurality of data users and transmit simultaneously. In the OMA scheme used in 4G and 5G, different frequency bandwidths are used between users to transmit data, thereby minimizing interference between users. In the OMA scheme, if each user frequently does not use the allocated frequency, frequency bandwidth may be wasted.

In a NOMA system, in order to simultaneously transmit data to a plurality of users, a base station needs to perform superposition coding. First, the base station 1310 respectively codes signals to be transmitted to each UE 1320 #1 to 1320 #2 and generates one signal through an encoder capable of superposition. Signals S₁ and S₂ for the respective UEs 1320 #1 and 1320 #2 may be superposition-coded as shown in FIG. 14. As a result, one signal X may be generated as shown in FIG. 14. A power allocation ratio may be implemented differently and has a relationship as shown in [Equation 2] below.

P=β₁+β₂ [Equation 2]

In [Equation 2], P denotes total downlink power of the base station, Ri denotes power allocated to S₁, and β₂ denotes power allocated to S₂.

A signal X obtained by superposing user signals is expressed as shown in [Equation 3] below.

X=\sqrt{Pβ₁}S₁+\sqrt{Pβ₂}S₂ [Equation 3]

The first UE 1320 #1 and the second UE 1320 #2 may receive the signal X and extract signals allocated thereto by using a successive interference cancellation method.

In a successive interference cancellation method, a UE extracts the strongest signal S₁ from a received signal X and removes the signal S₁ from the received signal X. If a signal from which the signal S₁ has been removed from the signal X is referred to as X₂, the UE extracts the strongest signal S₂ from X₂ and removes the signal S₂ from X₂. Each UE may extract n superposed signals in the same manner by sequentially removing the signals in order from the strongest signal.

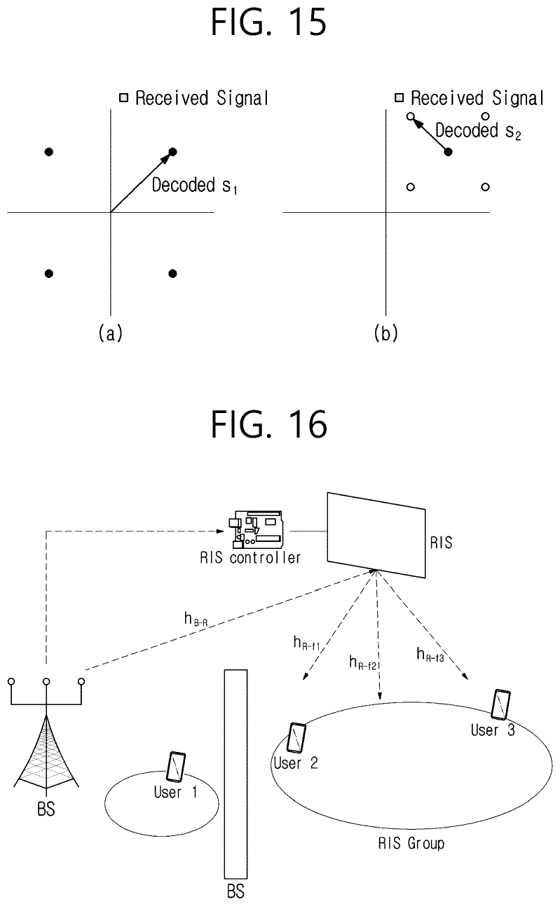

FIG. 15 shows a process for extracting signals S₁ and S₂ by a first UE 1320 #1 and a second UE 1320 #2, respectively, in the NOMA system communication environment of FIG. 13 based on an embodiment of the present disclosure. The first UE 1320 #1 and the second UE 1320 #2 respectively receive a signal X transmitted by the base station 1310 through channels h₁, h₂ in forms of Y₁ and Y₂. The first UE 1320 #1 may extract the strongest signal from Y₁ to extract a signal allocated thereto. For example, the base station may use quadrature phase shift keying (QPSK), which is one of modulation schemes. In this case, the base station 1310 performs superposition coding by varying power allocation ratios of signal S₁ and signal S₂. For example, if the base station 1310 adjusts a power allocation ratio in consideration of noise, a UE may determine that a phase of the S₁ signal corresponds to 450 if a phase of the signal Y received by the UE is 0 to 90°, regardless of the signal of S₂.

The second UE 1320 #2 decodes S₁, which has been allocated a greater power among the received signal Y₂, in the same way as the first UE 1320 #1, and may then remove S₁ from the original received signal Y₂ as shown in [Equation 4] below.

Y′₂=Y₂−\sqrt{Pβ₁}h₂S₁ [Equation 4]

In [Equation 4], Y′₂ denotes a signal obtained by removing the S₁ signal from Y₂.

The second UE 1320 #2 may extract a signal for S₂ by decoding Y′₂.

In NOMA technology, since signals are extracted sequentially from the strongest signal, a signal with lower power allocation may be more affected by noise. Therefore, a method for improving signal to interference plus noise ratio (SINR) of a UE may be considered. In NOMA technology, since a base station allocates higher power to signals transmitted to UEs with poor channel environments, if there are many UEs located in shadow areas, quality of service may be degraded. Therefore, to improve SINR of UEs in shadow areas, a communication environment using an RIS may be considered. The RIS is connected to the base station through RIS control. The RIS receives a reflection pattern from the base station and controls elements of the RIS based on the reflection pattern. The reflection pattern may include information on beam phase shift. As shown in FIG. 16, the base station may transmit signals to UEs located in shadow areas by using a beam utilizing the RIS through control of elements of the RIS.

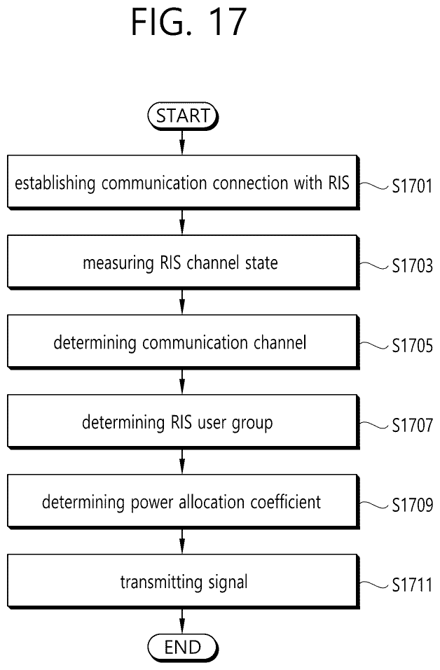

FIG. 17 shows a procedure for transmitting signals to a plurality of UEs by using an RIS at a base station based on an embodiment of the present disclosure. Although a method in which the base station transmits signals is shown in FIG. 17, the method may also be applied to a case where another device transmits signals. For example, the method may also be applied to a case where a UE transmits signals to other plurality of UEs by using the RIS.

Referring to FIG. 17, in step S1701, the base station may establish communication connection with the RIS to utilize the RIS. If the base station and the RIS are wirelessly connected, a random access procedure may be used. Since the base station may be connected to the RIS in at least one of a wired form and a wireless form, various procedures for the base station to control the RIS may be applied.

In step S1703, the base station measures an RIS channel state. The base station may change a reflection pattern by controlling the RIS. Different wireless channel environments may exist for each reflection pattern applicable to the RIS. Therefore, the RIS channel may be plural. To measure the RIS channel state, the base station may transmit a reference signal for each wireless channel environment. For example, the reference signal may be a CSI-RS. The base station may obtain at least one of RIS channel state information by transmitting the reference signal and receiving a response to the reference signal from a UE.

In step S1705, the base station determines a communication channel for transmitting a signal. The base station may determine the communication channel to be used for transmission based on the channel state information measured in step S1703. If at least one RIS channel is determined among the RIS channels, the base station may transmit a reflection pattern corresponding to the RIS channel to the RIS.

In step S1707, the base station determines an RIS user group. The RIS user group may be composed of UEs that receive signals through a channel using the RIS. The RIS user group may be determined in various ways. For example, the base station may classify a UE having a larger channel gain using the RIS than a channel gain without using the RIS as the RIS user group. The base station may also determine the RIS user group based on at least one of channel gain and location information of UEs.

In step S1709, the base station determines power allocation coefficients for signals to be transmitted to UEs. A method for determining power allocation coefficients in NOMA technology may be used as the method for determining the power allocation coefficients. That is, a method of allocating the largest power to a signal for a UE having the smallest channel gain may be used.

In step S1711, the base station transmits a signal based on the power allocation coefficients determined in step S1709. The base station may allocate power to signals to be transmitted to respective UEs and perform superposition coding. By utilizing superposition coding based on NOMA technology, the base station may transmit signals to a plurality of UEs through the same resource.

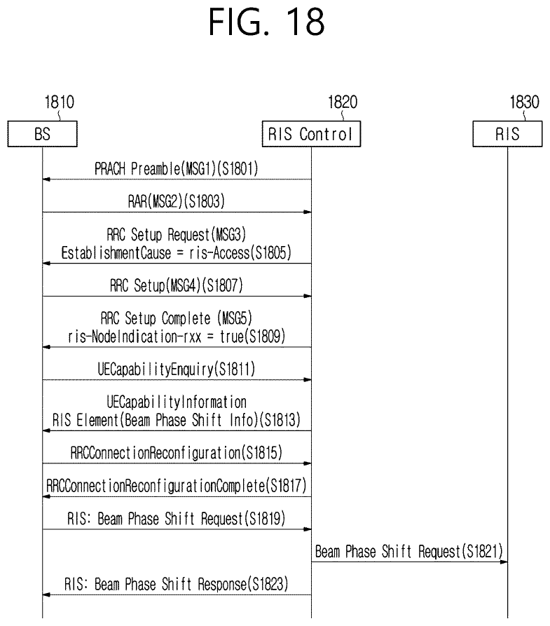

FIG. 18 shows an example procedure for establishing a connection with an RIS through an RRC connection at a base station based on an embodiment of the present disclosure. In step S1701 of FIG. 17, if communication connection between the base station and the RIS is performed wirelessly, the procedure of FIG. 18 may be used. Specifically, through the procedure of FIG. 18, the base station 1810 may connect to the RIS 1830 through an RIS controller 1820.

In step S1801, the RIS controller 1820 transmits a PRACH preamble (MSGT) to the base station 1810. The RIS controller 1820 may first perform synchronization with the base station 1810. The RIS controller 1820 may determine the PRACH preamble based on an MIB and an SIB1 received through the synchronization process.

In step S1803, the base station 1810 transmits a random access response (RAR) message to the RIS controller 1820. The RAR message may include a time advance (TA) and a cell-radio network temporary identity (C-RNTI) allocated to the UE.

In step S1805, the RIS controller 1820 transmits an RRC setup request message to the base station 1810. The RIS controller 1820 may transmit the RRC setup request message based on information related to radio resource allocation included in the received RAR message. The RIS controller 1820 may randomly determine a unique identifier for contention resolution. The RRC setup request message may include a unique identifier of the RIS controller 1820 for contention resolution. Additionally, The RRC setup request message may include an information element (IE) for distinguishing between a UE and the RIS. For example, if the IE of the RRC request message includes EstablishmentCause and the RIS controller 1820 performs a communication connection with the base station 1810, the value of EstablishmentCause may be assigned a value indicating ris-Access.

In step S1807, the base station 1810 transmits an RRC setup message to the RIS controller 1820. The RRC setup message may include the unique identifier of the RIS controller 1820 included in the RRC setup request message.

In step S1809, if the random access contention is resolved, the RIS controller 1820 transmits an RRC setup complete message to the base station 1810. The RIS controller 1820 may determine that the random access contention is resolved if its own unique identifier matches the unique identifier included in the RRC setup request message. The RRC setup complete message may include an IE representing that a connection is being established by the RIS controller 1820. For example, the RRC setup complete message may include an IE, ris-NodeIndication-rxx, representing that it is being established by the RIS controller 1820, and a value indicating true may be assigned to the ris-NodeIndication-rxx.

In step S1811, the base station 1810 transmits a capability enquiry message (e.g., UECapabilityEnquiry) to the RIS controller 1820 to know a capability of the RIS controller 1820. The base station 1810 may request resource information of the RIS 1830 to recognize an available RIS communication channel. The resource information of the RIS 1830 may include information related to a reflection pattern of the RIS 1830.

In step S1813, the RIS controller 1820 transmits a capability information message (e.g., UECapabilityInformation) to the base station 1810. The capability information message may include information for RIS elements and information for a changeable beam phase shift of the RIS 1830.

In step S1815, the base station 1810 transmits an RRC connection reconfiguration message to the RIS controller 1820. The base station 1810 may change a communication channel using the RIS 1830 by modifying a setting for the RRC connection. The RRC connection reconfiguration message may include at least one of information necessary for a wireless communication connection such as setting of a radio bearer, an RRC reconfiguration condition, etc.

In step S1817, the RIS controller 1820 completes communication setting based on the RRC connection reconfiguration message and then transmits an RRC connection reconfiguration complete message to the base station 1810.

In step S1819, the base station 1810 transmits a beam phase change request message to the RIS controller 1820 to change an RIS channel environment. The base station 1810 may determine a reflection pattern of the RIS 1830 through the beam phase change request message received in step S1813.

In step S1821, the RIS controller 1820 controls elements of the RIS 1830 based on the beam phase change request message received in step S1819.

In step S1823, the RIS controller 1820 transmits a beam phase change response message to the base station 1810. The base station 1810 may check that the reflection pattern of the RIS 1830 is changed by receiving the beam phase change response message. After that, the base station may perform communication with a UE by using an RIS channel. In addition, for measurement of a plurality of RIS channel state information, at least one of steps S1815 to S1823 may be repeatedly performed.

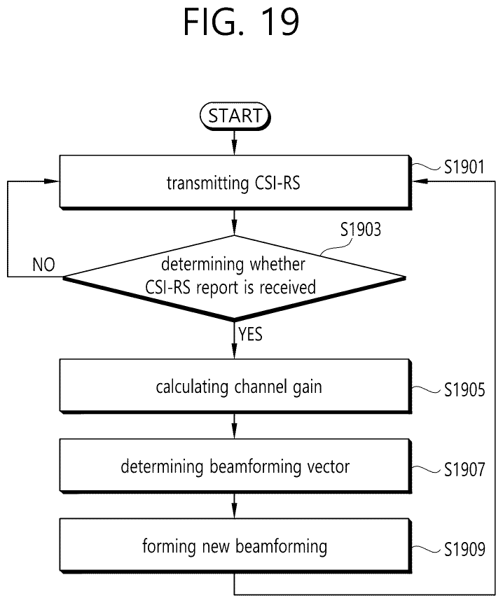

FIG. 19 shows a procedure for applying beamforming at a base station based on an embodiment of the present disclosure. The base station may receive channel state information from a UE and form a beam based on channel gain. In a NOMA system based on a power domain, power allocation of each UE may vary based on a channel condition, and accordingly, the base station may need to newly set a beam.

In step S1901, the base station transmits a CSI-RS to each UE. Each UE receives the CSI-RS and transmits a CSI-RS report to the base station. The CSI-RS report may include information for a channel state.

In step S1903, the base station determines whether the CSI-RS report is received. If the CSI-RS report is not received within a set time, the base station performs step S1901 again, and if the CSI-RS report is received, the base station performs the following step S1905.

In step S1905, the base station calculates a channel gain based on the received CSI-RS report. The base station determines a beamforming vector based on the calculated channel gain. A method for determining the beamforming vector may be variously determined based on an objective of a provider providing communication. For example, the base station may determine the beamforming vector so that a total channel gain of UEs is maximized. In another example, the base station may determine the beamforming vector based on a size and a variance of channel gains of the UEs.

In step S1909, the base station forms new beamforming by applying the determined beamforming vector. As described above, if the channel environment is changed, the base station may perform again from step S1901 to apply new beamforming. However, in a NOMA system to which an RIS is added, since the base station has to set beamforming based on measurement of an RIS channel, another procedure may be additionally required.

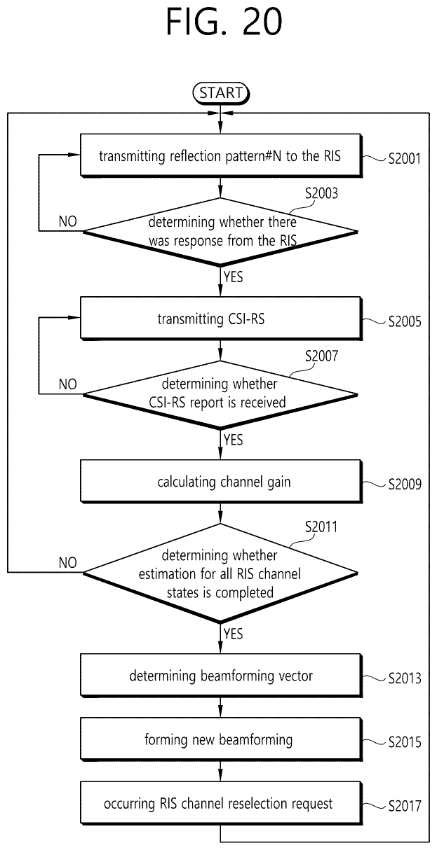

FIG. 20 shows a procedure for applying beamforming considering an RIS channel based on an embodiment of the present disclosure. If there are a plurality of reflection patterns applicable to the RIS, beamforming may be determined by measuring channel state information for all RIS channels.

In step S2001, the base station transmits an N-th reflection pattern to the RIS. The base station may control the RIS to receive a CSI-RS report for at least one or more reflection patterns based on a RIS capability information message received from the RIS. Accordingly, N may be set to a value equal to or less than the number of changeable reflection patterns included in beam phase change information. The base station may transmit the reflection pattern by using the procedure of step S1819 in FIG. 18.

In step S2003, the base station receives a response to the reflection pattern transmission from the RIS. If the base station receives the reflection pattern transmission response from the RIS, the base station may determine that control of the RIS has succeeded, and steps S2005 through S2009 may be performed for RIS channel estimation. If the base station does not receive the reflection pattern transmission response from the RIS, it performs step S2001 again to transmit the N-th reflection pattern to the RIS.

In steps S2005 through S2009, the base station calculates an RIS channel gain by using a CSI-RS. In FIG. 19, the base station may perform a procedure similar to steps S1901 through S1905 described above.

In step S2011, the base station determines whether estimation for all RIS channel states is completed. If estimation for all RIS channel states is completed, the base station performs step S2013 below. If estimation for all RIS channel states is not completed, the base station repeatedly performs from step S2001 by transmitting the next RIS reflection pattern.

In step S2013, the base station determines a beamforming vector based on measurement of all RIS channel states. A method for determining the beamforming vector may be variously determined based on an objective of a provider providing communication. For example, the base station may determine the beamforming vector so that the total channel gain of UEs is maximized. In another example, the base station may determine the beamforming vector based on a magnitude and a variance value of channel gains of the UEs. In another example, the base station may determine the beamforming vector based on a variation of channel gain using the RIS.

In step S2015, the base station forms new beamforming based on the determined beamforming vector. In beamforming for a channel using the RIS, the base station may transmit an RIS reflection pattern.

In step S2017, a UE or the base station may make an RIS channel reselection request due to a change in channel environment. The base station may perform again from step S2001 to estimate RIS channel state information for all reflection patterns.

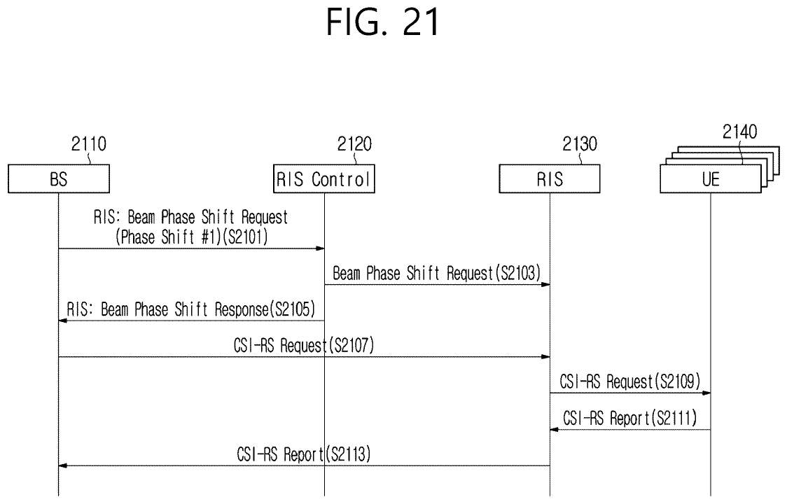

FIG. 21 shows an example of a signal flow between a base station 2110, an RIS controller 2120, an RIS 2130, and UEs 2140 for measuring RIS channel state information based on an embodiment of the present disclosure. Referring to FIG. 21, the base station 2110 may receive a plurality of RIS channel information based on a plurality of reflection patterns after completing an initial connection with the RIS 2130 through the procedure shown in FIG. 18.

In step S2101, the base station 2110 transmits a beam phase change request message to the RIS controller 2120 to change an RIS channel environment. The base station 2110 may recognize an available RIS channel environment through an initial connection procedure.

In step S2103, the RIS controller 2120 controls elements of the RIS 2130 based on the beam phase change request received in step S2101.

In step S2105, the RIS controller 2120 transmits a beam phase change response message to the base station 2110. The base station 2110 may confirm that a reflection pattern of the RIS 2130 has been changed by receiving the beam phase change response message.

In steps S2107 and S2109, the base station 2110 transmits a CSI-RS request message to the UEs 2140. The CSI-RS request message may be transmitted through the RIS channel. The CSI-RS request message may include a CSI-RS. The base station 2110 may transmit the CSI-RS request message to the RIS 2130, and the RIS 2130 may transmit the CSI-RS request message to the UEs 2140 by reflecting the transmitted signal.

In step S2111, the UEs 2140 transmit CSI-RS reports to the base station 2110. The UEs may measure an RIS channel gain based on the received CIS-RS and transmit channel state information to the base station 2110. The base station 2110 may determine an RIS channel for communication based on the received channel state information.

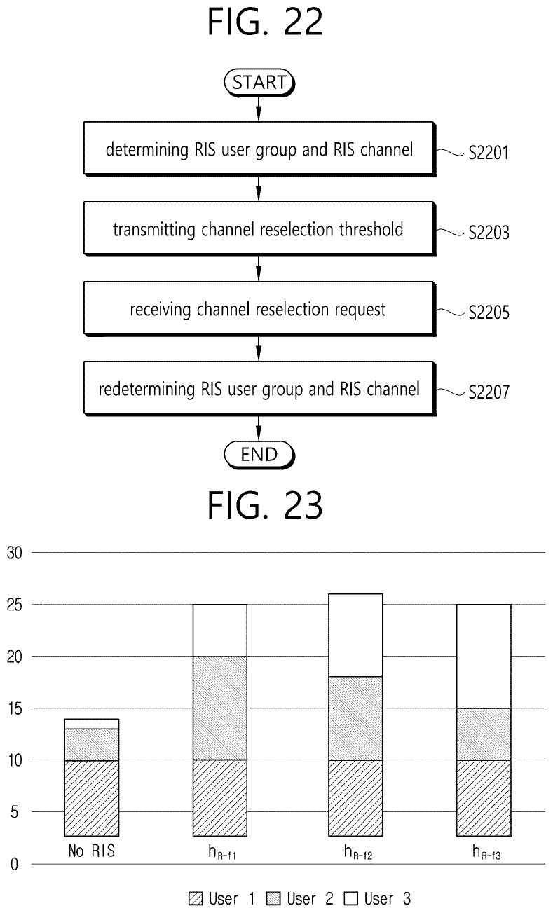

FIG. 22 shows an example of a procedure for determining an RIS channel at a base station based on an embodiment of the present disclosure. The base station may select an RIS channel for transmitting a NOMA signal based on channel information received from UEs. If a channel environment changes, channel reselection may be required. Accordingly, parameters for channel reselection may be set.

Referring to FIG. 22, in step S2201, the base station determines an RIS user group and an RIS channel. In an embodiment, as shown in FIG. 16, a first UE may directly communicate through a beam transmitted from the base station, while a second UE and a third UE may be in a situation in which communication with the base station is almost impossible due to an obstacle. In this case, channel gains between the base station and each UE may be as shown in [Equation 5] below.

|h_{BS-UE1}|²|≥|h_{BS-UE2}|²≥|h_{BS-UE3}|² [Equation 5]

In [Equation 5], h_{BS-UE1} denotes a channel gain between the base station and the first UE, h_{BS-UE2} denotes a channel gain between the base station and the second UE, and h_{BS-UE3} denotes a channel gain between the base station and the third UE.

The base station may form a new wireless channel through the RIS to improve the channel gains of the second UE and the third UE.

The channel between the base station and the RIS is denoted as h_{B-R}, and h_{R-fk}, (k=1, 2, . . . , N) represents N channels that may be formed between the RIS and the UEs, which may be created by phase shifts of the RIS.

The reflection pattern Φ of the RIS that may achieve the optimal SINR between the channel h_{B-R} and h_{R-fk} may be expressed as the following [Equation 6].

Φ=diag{λ₁e^{jθ1},λ₂e^{jθ2}, . . . ,λ_{N}e^{jθN}},where λ_{N}≤1,θN∈[0,2π] [Equation 6]

In [Equation 6], λ_{N} denotes a reflection amplitude created by a phase shift of the RIS.

For example, if the number of RIS channels that may be created by phase shift is 3 (N=3) as in FIG. 16, the channel gain of the UE and the base station for the phase shift of the RIS may be formed as (|h_{R-f1}Φh_{B-R}|², |h_{R-f2}Φh_{B-R}|², |h_{R-f3}Φh_{B-R}|²). The first UE may be located in an area not affected by the RIS, and the second UE and the third UE may be located in a position where an additional channel gain may be obtained by the RIS. In this case, the channel gain of each UE considering the k-th RIS channel may be expressed as shown in [Equation 7] below.

$$\begin{matrix}User 1 : {\vert {h}_{BS - UE 1} \vert}^{2} \\ User 2 : {\vert {h}_{BS - UE 2} + {h}_{R - fk} Φ {h}_{B - R} \vert}^{2} \\ User 3 : {\vert {h}_{BS - UE 3} + {h}_{R - fk} Φ {h}_{B - R} \vert}^{2}\end{matrix} \qquad [ Equation 7 ]$$

In [Equation 7], h_{BS-UE1} denotes a direct channel between the base station and the first UE, h_{BS-UE2} denotes a direct channel between the base station and the second UE, h_{BS-UE3} denotes a direct channel between the base station and the third UE, h_{R-fk} denotes a k-th channel between the RIS and a UE, and h_{B-R} denotes a channel between the base station and the RIS.

Referring to [Equation 7], the channel gains of the second UE and the third UE may be simultaneously affected by a phase shift of the RIS.

A signal received by a u-th UE considering a k-th RIS channel may be calculated as shown in [Equation 8] below.

$${y}_{u} = ( {h}_{BS - {UE}_{u}} + {h}_{R - fk} Φ {h}_{B - R} ) {\sum }_{l = 1}^{{N}_{u}} {w}_{l} {x}_{l} + {n}_{u} \qquad [ Equation 8 ]$$

In [Equation 8], yᵤ denotes a signal received by the UE, xₗ denotes data transmitted by the base station to an l-th UE, wₗ denotes a power allocation coefficient of a signal transmitted to the l-th UE, Nᵤ denotes the number of UEs connected to the base station, and nᵤ denotes Gaussian noise.

In NOMA system based on a power-domain, the power transmitted by the base station to each UE may be allocated in inverse proportion to the magnitude of the channel gain between the base station and the UE. For example, in a communication environment such as that shown in FIG. 16, if there is no RIS, the channel gains for each UE may be as shown in [Equation 9] below.

h_{BS-UE1}≥h_{BS-UE2}≥h_{BS-UE3} [Equation 9]

In this case, w₁ should be determined as shown in [Equation 10] below.

w_{UE1}≤w_{UE2}≤w_{UE3} [Equation 10]

In [Equation 10], w_{UE1} denotes a power allocation coefficient for the first UE, w_{UE2} denotes a power allocation coefficient for the second UE, and w_{UE3} denotes a power allocation coefficient for the third UE.

In a channel without considering the RIS, the Gaussian noise may be assumed to have a mean of 0 and a variance of σₙ². Since the signals for the second UE and the third UE are allocated greater power, the first UE may receive the signal for the first UE after removing the signals for the second UE and the third UE through successive interference cancellation. Accordingly, y₁, the SINR of the first UE may be expressed as shown in [Equation 11] below.

y₁=(|h_{BS-UE1}|²w₁²)/σₙ² [Equation 11]

As described above, since the third UE is allocated greater power, the second UE may receive a signal in which the signal for the third UE is removed through successive interference cancellation. Since the signal for the first UE is not removed, the signal for the first UE is added as noise. Accordingly, y₂, the SINR of the second UE may be expressed as shown in [Equation 12] below.

$${y}_{2} = \frac{{\vert {h}_{BS - UE 2} \vert}^{2} {w}_{2}^{2}}{{\vert {h}_{BS - UE 1} \vert}^{2} {w}_{1}^{2} + {σ}_{n}^{2}} \qquad [ Equation 12 ]$$

In a signal to be received by the third UE, the signals for the first UE and the second UE are added as noise, and since the signal for the third UE is allocated the greatest power, it may be processed first. Accordingly, the SINR of the third UE may be expressed as shown in [Equation 13] below.

$${y}_{3} = \frac{{\vert {h}_{BS - UE 3} \vert}^{2} {w}_{3}^{2}}{{\vert {h}_{BS - UE 1} \vert}^{2} {w}_{1}^{2} + {\vert {h}_{BS - UE 2} \vert}^{2} {w}_{2}^{2} + {σ}_{n}^{2}} \qquad [ Equation 13 ]$$

Generalizing this relationship, yᵤ, the SINR of the u-th UE may be expressed as shown in [Equation 14] below.

$${y}_{u} = \frac{{\vert {h}_{BS - UEu} \vert}^{2} {w}_{u}^{2}}{{\sum }_{l = 1}^{u - 1} {\vert {h}_{BS - UEl} \vert}^{2} {w}_{l}^{2} + {σ}_{n}^{2}} \qquad [ Equation 14 ]$$

In [Equation 14], h_{BS-UEu} denotes a channel between the u-th UE and the base station, and wᵤ denotes a power allocation coefficient for the u-th UE.

Unlike the case described above, if a channel using the RIS is used, the channel gain may change whenever the reflection pattern of the RIS is changed. Accordingly, if the RIS channel is additionally considered, the overall channel gain may be improved, but the order of power allocation may change as a result. For example, if the RIS is used, the channel gain may be changed as shown in FIG. 23. Which channel is used to transmit a NOMA signal may be differently implemented based on the intention of a designer of the communication system. For example, the base station may determine to use a communication channel in which the sum of channel gains of the UEs is the largest. In another example, the base station may determine to use a channel having the largest minimum channel gain value. In another example, the base station may determine an RIS channel based on the locations of the UEs and the sum of the channel gains. After determining the RIS channel for communication, the base station may determine an RIS user group to use the RIS channel. For example, the base station may classify a UE having a larger channel gain using the RIS than a channel gain of a direct channel between the base station and the UE as the RIS user group.

In step S2203, the base station transmits a channel reselection threshold to the UEs. If the channel environment deteriorates for a specific UE due to a change of the channel environment, the base station may need to perform an RIS channel reselection operation. The base station may transmit a threshold for channel reselection to the UEs.

In step S2205, the base station receives a channel reselection request from a UE. If a channel gain measured by the UE satisfies a specific condition, the UE may request channel reselection from the base station. The specific condition described above may be satisfied if specific UE measures a channel gain that is less than a predetermined reference value than a channel reselection threshold received from a base station. The predetermined reference value may be 3 db.

In step S2207, the RIS user group and the RIS channel are re-determined. The base station that has received the reselection request re-determines the RIS user group and the RIS channel. The base station may perform a procedure similar to step S2201.

In FIG. 22, the above-described procedure may be started after the base station and the RIS perform an RRC connection or may be started by reselection request or a channel selection from a UE. The channel gain of an RIS channel may be measured through a CIS-RS report transmitted by the UE. If measurement for all N RIS channels is completed, the base station may recognize the channel gains of the RIS channels for all UEs. Based on the channel gains of the RIS channels for all UEs, the optimal RIS channel and reflection pattern may be determined.

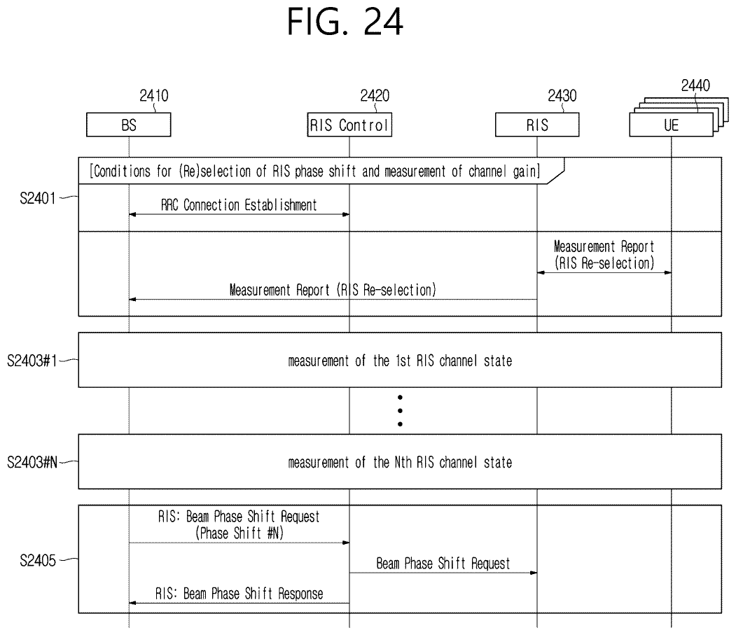

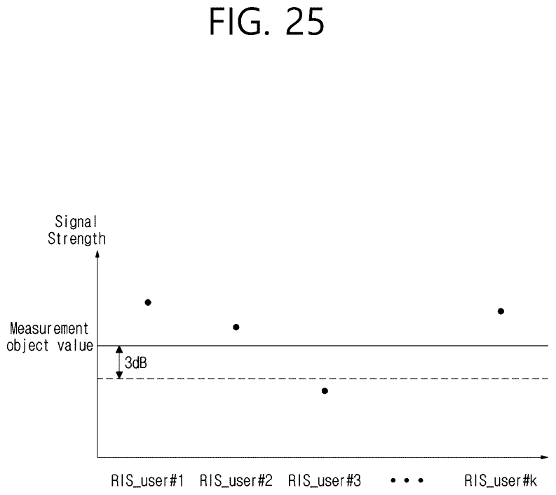

FIG. 24 shows an example of a signal flow for measuring an RIS channel gain and determining a reflection pattern at a base station 2410 based on an embodiment of the present disclosure. The number of channels that the RIS 2430 may change is determined based on characteristics of elements of the RIS 2430 and is assumed to be N.

Referring to FIG. 24, in step S2401, the base station 2410 may measure an RIS channel gain and determine whether it corresponds to a condition for selecting an RIS reflection pattern. For example, the base station 2410 may initiate measurement of the RIS channel gain if the RIS controller 2420 establishes a connection with the RIS 2430 through an RRC connection establishment procedure. In this case, the base station 2410 may perform the RRC connection with the RIS 2430 through steps S1801 to S1817 of FIG. 18. In another example, the base station 2410 may initiate measurement of the RIS channel gain by receiving an RIS channel reselection message from a UE.

In steps S2403 #1 to S2403 #N, the base station 2410 performs measurement for all RIS channel states. In this case, the base station 2410 may measure the channel state for each RIS channel through steps S2101 to S2113 of FIG. 21 for measurement of each RIS channel state. The base station 2410 may receive all RIS channel gains from the UEs 2440.

In step S2405, the base station 2410 determines an RIS channel for communication based on the received RIS channel gains and may determine an optimized reflection pattern based on the determined RIS channel. Although FIG. 24 shows that the base station 2410 determines the channel for communication with the UEs 2440 as the N-th RIS channel, the base station 2410 may also select a k-th RIS channel regardless of the measured order based on the RIS channel gain. The base station 2410 changes the reflection pattern of the RIS 2430 based on the determined reflection pattern. The base station 2410 may change the reflection pattern of the RIS 2430 through steps S1819 to S1823 of FIG. 18.

In the above embodiment, although the base station measures all N reflection patterns, for efficient use of communication resources, the base station may select an optimal RIS channel after measuring only a part of the N reflection patterns.

In the communication environment shown in FIG. 23, if the RIS is not used, the base station should allocate to satisfy w_{UE1}≤w_{UE2}≤w_{UE3}, as described above. However, if using the channel h_{R-f3} through the RIS, the channel gain of the third UE may become better than that of the first UE, as shown in [Equation 15].

|h_{BS-UE3}+h_{R-f3}Φh_{B-R}|²≥|h_{BS-UE1}|² [Equation 15]

If the channel condition changes as shown in [Equation 15], if the base station allocates power while maintaining w_{UE1}≤w_{UE3}, only the SINR of the third UE is maximized, and the SINRs of the first and second UEs are relatively significantly degraded. In this case, user fairness, which is one of the issues discussed in NOMA systems, may be further degraded. Therefore, a new power allocation scheme is required to prevent this.

A power allocation scheme considering RIS users may be proposed to solve the user fairness problem. If RIS is not used (No RIS), the base station may obtain channel information from each UE based on the CIS. If the RIS is used thereafter, the base station may change the RIS reflection pattern through the RIS controller. The base station may form a k-th RIS channel h_{R-fk} through a phase shift of the RIS and obtain channel information from each UE based on the CIS. The base station may calculate channel gains based on the obtained channel information and may calculate an average value and a variance value of the channel gain for each UE. For example, in a communication environment such as FIG. 23, by obtaining channel information for each channel, the base station may calculate channel gains, average values, and variance values as shown in [Table 2].

TABLE 2

| | User 1 | User 2 | User 3 |
|---|---|---|---|
| NO RIS | 10 | 3 | 1 |
| h_{R-f1} | 10 | 10 | 5 |
| h_{R-f2} | 10 | 8 | 8 |
| h_{R-f3} | 10 | 5 | 10 |
| Avg | 10 | 6.5 | 6 |
| Var | 0 | 7.25 | 7.5 |

In [Table 2], Avg refers to the average of the channel gains measured for each UE, and Var refers to the variance of the channel gains measured for each UE. The base station may distinguish between UEs located near the base station and UEs located at the edge or in poor channel conditions due to obstacles based on the channel gains of the UEs. Specifically, the base station may distinguish between UEs affected by the RIS and those not affected by the RIS based on the variance values if the RIS channel is added. For example, the first UE has a relatively large channel gain regardless of the presence or absence of the RIS channel. If the RIS channel exists, the variance value is also small, so the base station may determine that there is no significant correlation between the first UE and the RIS channel. Therefore, the base station may determine the first UE as a UE located near the base station and as a UE hardly affected by the RIS channel.

If the RIS channel is not configured, the channel gains of the second UE and the third UE are relatively low, but if the RIS channel is configured, the channel gains of the second UE and the third UE are improved. In addition, since the channel gains of the second UE and the third UE vary based on each RIS channel h_{R-fk}, they have larger variance values compared to the first UE. Therefore, the base station may classify the second UE and the third UE as an RIS user group located in the RIS region.

The method by which the base station classifies the UEs into an RIS group may be implemented in various ways. For example, the base station may determine a priority table based on the channel gains and variances calculated through the CIS status reports received from the UEs.

The priority table may be determined as shown in [Table 3] below by arranging the measured channel gain values in descending order and the variance values in ascending order.

TABLE 3

| | | | | | |
|---|---|---|---|---|---|
| {Var(1), | {Var(1), | {Var(1), | {Var(1), | . . . | {Var(1), |
| CG(1)} | CG(2)} | CG(3)} | CG(4)} | | CG(M)} |
| {Var(2), | {Var(2), | {Var(2), | {Var(2), | . . . | {Var(2), |
| CG(1)} | CG(2)} | CG(3)} | CG(4)} | | CG(M)} |
| {Var(3), | {Var(3), | {Var(3), | {Var(3), | . . . | {Var(3), |
| CG(1)} | CG(2)} | CG(3)} | CG(4)} | | CG(M)} |
| {Var(4), | {Var(4), | {Var(4), | {Var(4), | . . . | {Var(4), |
| CG(1)} | CG(2)} | CG(3)} | CG(4)} | | CG(M)} |
| . . . | . . . | . . . | . . . | . . . | . . . |
| {Var(N), | {Var(N), | {Var(N), | {Var(N), | . . . | {Var(N), |
| CG(1)} | CG(2)} | CG(3)} | CG(4)} | | CG(M)} |

In Table 3, Var(m) represents the m-th smallest variance value among the measured variances, and CG(n) represents the n-th largest channel gain value among the measured channel gains. The lower the variance value and the higher the channel gain, the higher the priority may be. Based on Table 3, the base station may find a reference UE having the highest priority. The priority between the variance value and the channel gain value may be implemented differently based on the designer of the communication system. For example, the smallest variance, that is, Var(1), may be given the highest priority, and the UE with the highest channel gain among the UEs may be the reference UE.

Specifically, in the communication environment as shown in FIG. 23, the base station may obtain the channel gains, the average values of the channel gains, the variances of the channel gains as shown in Table 2. In this case, the priority table is as shown in [Table 4] below.

TABLE 4

| | | | | |
|---|---|---|---|---|
| {0, 10} | {0, 8} | {0, 5} | {0, 3} | {0, 1} |
| {7.25, 10} | {7.25, 8} | {7.25, 5} | {7.25, 3} | {7.25, 1} |
| {7.5, 10} | {7.5, 8} | {7.5, 5} | {7.5, 3} | {7.5, 1} |

The base station checks whether there exists a UE corresponding to {0, 10} by using the priority table. If no UE corresponding to {0, 10}exists, the base station checks whether there exists a UE corresponding to {0, 8}. That is, the objective of the base station is to find a UE corresponding to {min(Var), max(CG)}. The base station may determine to prioritize a UE having a lower variance value over a UE having a higher channel gain. Therefore, the priority table based on [Table 4] may be expressed as shown in [Table 5] below.

TABLE 5

| priority | variance | channel gain |
|---|---|---|
| 1 | 0 | 10 |
| 2 | 7.25 | 8 |
| 3 | 7.5 | 5 |
| 4 | — | 3 |
| 5 | — | 1 |

That is, the base station may select 0, which has the lowest variance in the first order in [Table 5], and then search in order of highest channel gain to determine whether there exists a corresponding UE. By determining the UE having the lowest variance value as the reference UE, the base station may set the RIS channel as a channel having high variability and classify as many UEs as possible into the RIS user group. In the communication environment as shown in [Table 2], since there exists a UE corresponding to {0, 10}, the base station determines the first UE as the reference UE. The reference UE may be used when performing a channel reselection procedure or determining the RIS user group described below. The base station may determine an RIS user group using an RIS channel. First, the base station selects a channel h_{R-f(selected)} having the highest channel gain among the channels obtainable through the RIS phase shift. That is, h_{R-f(selected)} may be determined as a channel having the highest average channel gain of all UEs obtained through the RIS channel state estimation. For example, in the communication environment as shown in [Table 2], h_{R}-f₂ may be selected. The base station may determine a UE with a non-zero variance value of a UE whose channel gain of the selected h_{R-f(selected)} is measured to be higher than the channel gain of No RIS as a RIS user group. For example, in the communication environment as shown in [Table 2], the second UE and the third UE may be classified as the RIS user group. The method for determining the RIS user group may be implemented in various ways. In another example, the base station may determine, as an RIS user group, a UE for which the difference between the variance value of the UE whose channel gain of the selected h_{R-f(selected)} is measured to be higher than a channel gain of No RIS and the variance value of the reference UE is equal to or greater than a specific threshold.

In another example, the base station may determine a UE that does not use the NOMA technology for a communication environment of a certain quality or higher. In the selected channel environment, a UE having a channel gain lower than a specific threshold than the channel gain of the reference UE may be excluded from communication using the NOMA technology.

The base station may transmit a measurement object value for determining channel reselection and an RIS phase shift to the RIS user group. The measurement object value for reselection may be implemented in various ways. For example, the base station may include a threshold for channel reselection in the measurement object value. It may determine the minimum channel gain among all UEs measured through the channel h_{R-f(1~N)} as the threshold for channel reselection. If the threshold is determined as described above, if the channel gain of the serving cell measured by a UE belonging to the RIS user group is 3 db lower than the lowest value of the set channel gain, the UE may request the base station to reset the RIS channel. Alternatively, if the channel gain of the serving cell measured by a UE belonging to the RIS user group is equal to or less than the channel gain measured in No RIS, a RIS channel reset may be requested. Specifically, as shown in FIG. 25, if each UE measures the channel gain of a serving cell, RIS_user#3, which measures 3 db lower than the measurement object value, may request RIS channel reselection to the base station.

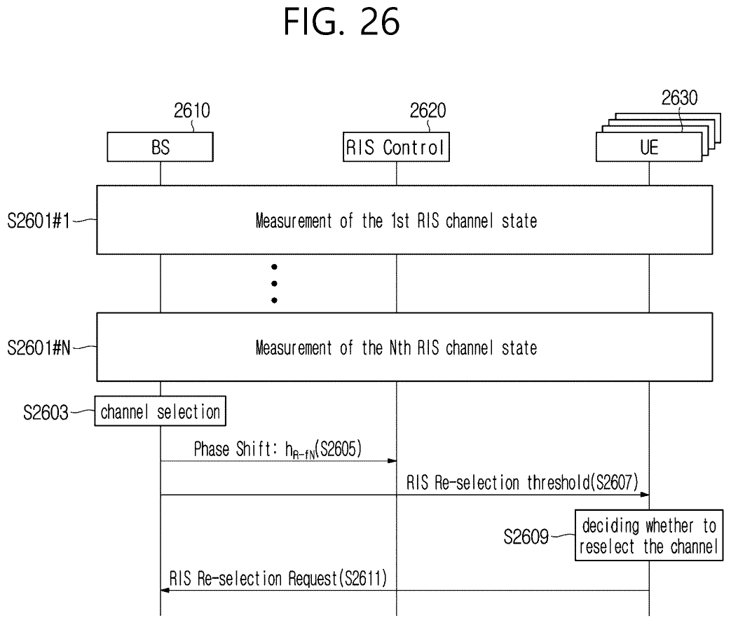

FIG. 26 shows an example of a signal flow between a base station 2610, an RIS controller 2620, and UEs 2630 for obtaining channel information and reselecting an RIS channel based on an embodiment of the present disclosure. FIG. 26 shows the procedure after the base station 2610 and the RIS controller 2620 establish an RRC connection through the RRC procedure described above. At this time, it is assumed that the number of RIS reflection patterns available to the base station 2610 is N.

In steps S2601 #1 to S2601 #N, the base station 2610 measures N RIS channel states. The base station 2610 may perform steps S2101 to S2113 of FIG. 21 to measure each RIS channel state.

In step S2603, the base station 2610 determines an RIS channel to be used for communication. For example, the channel with the largest average channel gain measured by the UEs 2630 for each channel may be selected as the RIS channel. In another example, it may select the minimum channel gain value among the channel gain values measured by the UEs 2630 for each channel, and determine as the RIS channel a channel having the largest minimum channel gain among the selected minimum channel gain values for each channel. After selecting the RIS channel, the base station 2610 may determine an RIS user group.

In step S2605, the base station 2610 transmits a signal related to a beam pattern based on the selected RIS channel to the RIS controller 2620. The signal related to the beam pattern may be an RIS phase change message. The RIS controller 2620 controls the RIS elements based on the received phase change message.

In step S2607, the base station 2610 transmits a threshold for RIS channel reselection to the UEs 2630. The threshold for RIS channel reselection may be determined based on the RIS channel gains measured in steps S2601 #1 to S2601 #N. For example, the base station may determine the minimum value among the measured RIS channel gains as the threshold for RIS channel reselection.

In step S2609, the UEs 2630 determine whether to perform channel reselection by monitoring the channel state. For example, a UE whose measured channel gain is 3 dB lower than the threshold received in step S2607, or whose channel gain using the RIS is measured to be lower than that in the No RIS case, may determine to perform channel reselection. UEs belonging to the RIS user group may monitor only the state of the RIS channel, unlike in existing communication systems. Since the RIS channel is a channel created under special conditions by the base station controlling the RIS, the base station 2610 and the UEs 2630 may not use a method of measuring adjacent frequency bands through measurement objects used in existing communication systems.

In step S2611, a UE that has determined to perform channel reselection transmits a channel reselection request message to the base station 2610. The base station 2610 that receives the channel reselection request message returns to step S2601 and performs RIS channel measurement.

In FIG. 26, it is shown that the RIS channel reselection procedure starts if the channel gain is 3 db lower than the channel reselection threshold, but the 3 db value may be replaced with a predetermined value by the communication environment designer.

[Table 6] below shows an example of a structure of a measurement object transmitted to the RIS user group based on an embodiment of the present disclosure.

TABLE 6
MeasConfig IE
MeasConfig ::= SEQUENCE { measObjectToRemoveList MeasObjectToRemoveList
OPTIONAL, -- Need N
measObjectToAddModList MeasObjectToAddModList OPTIONAL, -- Need N
reportConfigToRemoveList ReportConfigToRemoveList OPTIONAL, -- Need N
reportConfigToAddModList ReportConfigToAddModList OPTIONAL, -- Need N
measIdToRemoveList MeasIdToRemoveList OPTIONAL, -- Need N
measIdToRemoveList MeasIdToAddModList OPTIONAL, -- Need N
...
}
MeasObjectToAddModList IE
MeasObjectToAddModList ::= SEQUENCE (SIZE (1 .. maxNrofObjectId)) OF
MeasObjectToAddMod
MeasObjectToAddMod ::= SEQUENCE {
measObjectId MeasObjectId,
measObject CHOICE {
measObjectNR MeasObjectNR,
...,
measObjectEUTRA MeasObjectEUTRA,
measObjectUTRA-FDD-r16 MeasObjectUTRA-FDD-r16,
measObjectNR-SL-r16 MeasObjectNR-SL-r16,
measObjectCLI-r16 MeasObjectCLI-r16,
measObjectRxTxDiff-r17 MeasObjectRxTxDiff-r17,
measObjectRelay-r17 SL-MeasObject-r16,
measObjectRIS MeasObjectRIS
}
}
MeasObjectRIS
MeasObjectRIS ::= SEQUENCE { triggeredRISReSel BOOLEAN
OPTIONAL,
triggeredNoRISThreshold BOOLEAN OPTIONAL,
}
ReportConfigToAddModLIst IE
ReportConfigToAddModList ::= SEQUENCE (SIZE (1 .. maxReportConfigId)) OF
ReportConfigToAddMod
ReportConfigToAddMod ::= SEQUENCE {
reportConfigId ReportConfigId,
reportConfig CHOICE {
reportConfigNR ReportConfigNR,
reportConfigRIS ReportConfigRIS,
...,
}
ReportConfigRIS, EventTriggerRISConfig
ReportConfigRIS ::= SEQUENCE { reportType CHOICE {
eventTriggered EventTriggerRISConfig,
}
}
EventTriggerRISConfig ::= SEQUENCE {
eventId CHOICE {
eventRISReSel SEQUENCE {
RISReSelThreshold MeasTriggerQuantity,
NoRISThreshold Meas TriggerQuantity,
}
}
MeasTriggerQuantity ::= CHOICE {
rsrp RSRP-Range,
rsrq RSRQ-Range,
sinr SINR-Range
}

As shown in [Table 6], MeasObjectToAddMod, an IE for adding or modifying measurement objeels may include a measObjectRIS parameter. The measObjectRIS parameter may determine the value of triggeredRISReSel based on whether the RIS channel reselection condition is triggered based on the measurement object at the UE. Alternatively, the value of triggeredNoRISThreshold may be determined based on whether the channel gain is measured to be lower than that in the No RIS state. In addition, ReportConfigToAddMod, an IE for adding or modifying report configurations for RIS configuration reports may include a reportConfigRIS parameter.

If the UE determines that ReportConfigRIS is satisfied, the UE may transmit a measurement report including the result value of MeasObjectRIS to the base station. ReportConfigRIS may include reportType and EventTriggerRISConfig, and EventTriggerRISConfig may include information related to RISReSelThreshold, which is a threshold for channel reselection, and NoRISThreshold, which is a threshold of the No RIS channel. The base station may transmit a threshold for channel reselection by transmitting ReportConfigRIS, which is a measurement object IE, to the UE. The base station transmits to the UE a request to report by using triggeredRISReSel or triggeredNoRISThreshold through MeasObjectRIS.

[Table 6] is an example of the present disclosure and the present disclosure is not limited to the structure shown in [Table 6]. For example, an IE, parameter names, detailed IE structure may be changed. That is, it may be embodied in other specific forms as long as it does not deviate from the technical idea and essential features.

If the reference UE is determined through the procedure described above, the base station may determine a power allocation coefficient. For communication using the NOMA technology, the base station may determine the reference UE as a UE to which minimum power is allocated. In a downlink situation using the NOMA technology, a signal for the UE to which minimum power is allocated is superposed at the last stage using superposition coding. Therefore, the SINR is calculated after the superposed signals of other users are removed through successive interference cancellation. If the k-th RIS channel among the RIS channels is selected, the power allocation coefficient of the UE to be allocated with minimum power may be expressed as [Equation 16] below.

$${γ}_{1} = \frac{{\vert {h}_{BS - UE 1} + {h}_{R - fk} Φ {h}_{B - R} \vert}^{2} {w}_{1}^{2}}{{σ}_{n}^{2}} \qquad [ Equation 16 ]$$

In [Equation 16], γ₁ denotes the SINR of the first UE that is allocated minimum power, |h_{BS-UE1}+h_{R-fk}Φh_{B-R}| denotes the channel gain of the first UE, and w₁ denotes the power allocation coefficient allocated to the first UE.

The base station may obtain in advance from the UE the minimum SINR γ₁_{^{(th)}} for decoding of the first UE. In consideration of the minimum SINR y₁_{^{(th)}}, the base station may determine a power allocation coefficient w₁ satisfying [Equation 17] for the first UE.

$${w}_{1}^{2} \geq \frac{{γ}_{1}^{( th )} {σ}_{n}^{2}}{{\vert {h}_{BS - UE 1} + {h}_{R - fk} Φ {h}_{B - R} \vert}^{2}} \qquad [ Equation 17 ]$$

The second UE, which is allocated power second, must have a larger power allocation than the first UE. Therefore, the base station may determine a power allocation coefficient w₂ satisfying [Equation 18] for the second UE.

$$\begin{matrix}{γ}_{2} = \frac{{\vert {h}_{BS - UE 2} + {h}_{R - fk} Φ {h}_{B - R} \vert}^{2} {w}_{2}^{2}}{{\vert {h}_{BS - UE 1} + {h}_{R - fk} Φ {h}_{B - R} \vert}^{2} {w}_{1}^{2} {σ}_{n}^{2}} \\ {w}_{2}^{2} = \frac{{γ}_{2} {\vert {h}_{BS - UE 1} + {h}_{R - fk} Φ {h}_{B - R} \vert}^{2} {w}_{1}^{2} {σ}_{n}^{2}}{{\vert {h}_{BS - UE 2} + {h}_{R - fk} Φ {h}_{B - R} \vert}^{2}} \\ {w}_{2}^{2} \geq {\vert {h}_{BS - UE 1} + {h}_{R - fk} Φ {h}_{B - R} \vert}^{2} {w}_{1}^{2} \frac{{γ}_{2}^{( th )} {σ}_{n}^{2}}{{\vert {h}_{BS - UE 2} + {h}_{R - fk} Φ {h}_{B - R} \vert}^{2}}\end{matrix} \qquad [ Equation 18 ]$$

In [Equation 18], γ₂ denotes the SINR of the second UE, |h_{BS-UE2}+h_{R-fk}Φh_{B-R}| denotes the channel gain of the second UE, w₂ denotes the power allocation coefficient allocated to the second UE, and γ₂_{^{(th)}} denotes the minimum SINR required for decoding of the second UE.

The base station may determine power allocation coefficients for the third UE and the fourth UE in the same manner. Accordingly, the base station may determine a power allocation coefficient wᵤ satisfying [Equation 19] for the u-th UE.

$${w}_{u}^{2} \geq {\sum }_{i = 1}^{u - 1} {\vert {h}_{BS - UEi} + {h}_{R - fk} Φ {h}_{B - R} \vert}^{2} {w}_{i}^{2} ( \frac{{γ}_{u}^{( th )} {σ}_{n}^{2}}{{\vert {h}_{BS - UEu} + {h}_{R - fk} Φ {h}_{B - R} \vert}^{2}} ) \qquad [ Equation 19 ]$$

In [Equation 19], wᵤ denotes the power allocation coefficient allocated to the u-th UE, |h_{BS-UEi}+h_{R-fk}Φh_{B-R}| denotes the channel gain of the i-th UE, wᵢ denotes the power allocation coefficient allocated to the i-th UE, γᵤ_{^{(th)}} denotes the minimum SINR required for decoding of the u-th UE, and |h_{BS-UEu}+h_{R-fk}Φh_{B-R}|² denotes the channel gain of the u-th UE.

Through [Equation 19], each UE may determine the minimum power required to decode the signal transmitted to itself. The base station may apply power allocation coefficients using [Equation 19] and transmit sequentially superposed signals to the UEs. Each UE may receive its corresponding signal through successive interference cancellation. The base station starts with the reference UE as the first UE for power allocation, and then allocates power in ascending order of channel gain. That is, except for the first reference UE, the order of the remaining UEs is determined only by the channel gain. Therefore, the power allocation order may be {min(Var), max(CG)}, {*, max(CG)−1}, {*, max(CG)−2}, {*, max(CG)−3} . . . {*, min(CG)}.

If the base station allocates power using the minimum power value through [Equation 19], remaining power of the base station may occur. In this case, the base station may allocate power equal to or greater than the minimum power required for decoding to the UEs, and may additionally allocate power to the UEs to guarantee maximum SINR. The base station may determine the remaining power P′, which is the total power P excluding the minimum allocated power, as shown in [Equation 20].

Total Power P−Minimum Power Allocation=P′ [Equation 20]

The base station may allocate the remaining power P′ to each UE in proportion as shown in [Equation 21].

$${EP}_{user 1} : {EP}_{user 2} : {EP}_{user 3} = \frac{1}{{CG}_{user 1}} : \frac{1}{{CG}_{user 2}} : … : \frac{1}{{CG}_{userN}} \qquad [ Equation 21 ]$$

In [Equation 21], EPᵤₛₑᵣₖ denotes the extra power allocation for the k-th UE, and CGᵤₛₑᵣₖ denotes the channel gain of the k-th UE.

Therefore, the base station may perform minimum power allocation to each UE using [Equation 19], and may additionally allocate the remaining power P′ to the UEs based on the extra power allocation ratio based on [Equation 21]. Thereafter, the base station may perform superposition coding on the signal for each UE by utilizing NOMA technology, and then transmit it to multiple UEs through a single frequency resource.

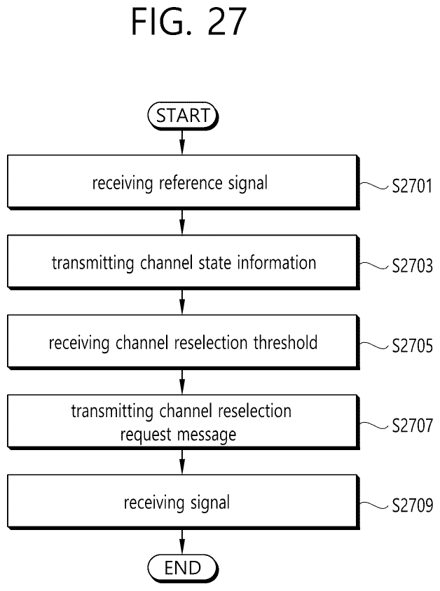

FIG. 27 shows an operation procedure for performing NOMA communication at a UE based on an embodiment of the present disclosure.

In step S2701, the UE receives a reference signal from the base station. The base station may transmit reference signals corresponding to a plurality of beam patterns to the UE in order to measure an RIS channel. The UE receives the reference signal and estimates channel state information.

In step S2703, the UE transmits channel state information to the base station. The channel state information may include channel gain. The base station may identify RIS channel gain based on the channel state information transmitted by the UE. As described above, the base station may determine a reference UE, and an RIS user group, a channel reselection threshold based on the RIS channel gain.

In step S2705, the UE receives a channel reselection threshold from the base station. The base station may also transmit a measurement object including the channel reselection threshold.

In step S2707, if the measured channel gain is 3 dB lower than the channel reselection threshold or lower than that in a No-RIS state, the UE may transmit a channel reselection request message to the base station. A base station that receives a channel reselection request message may perform a procedure to reselect the RIS channel by transmitting a reference signal again.

In step S2709, the UE receives a signal to which a power allocation coefficient of the NOMA technology is applied. The UE may extract the signal for itself from the received signal through successive interference cancellation.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL AVAILABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method, comprising:
establishing, by a base station, a radio resource control (RRC) connection with a first device;
receiving, by the base station, a plurality of channel state information based on the RRC connection;
determining, by the base station, a communication channel based on the plurality of measured channel state information;
determining, by the base station, power allocation coefficients of user equipments (UEs) based on the communication channel; and
transmitting, by the base station, a signal based on the power allocation coefficients,
wherein establishing the RRC connection comprises: receiving reflection pattern information that is changeable through reconfigurable intelligent surface (RIS) control by the first device, and
wherein the signal is transmitted, after being generated by superposition coding, to the UEs through an RIS channel.

2. The method of claim 1, further comprising:
determining an RIS user group based on the plurality of channel state information;
transmitting a channel reselection object to the UEs; and
receiving a channel reselection request from a UE belonging to the RIS user group.

3. The method of claim 2, wherein determining the RIS user group comprises:
determining channel gains of the UEs based on the channel state information, and
determining a UE, as the RIS user group, in which a channel gain using the RIS is greater than a channel gain not using the RIS.

4. The method of claim 3, wherein receiving the plurality of channel state information comprises:
transmitting, to the first device, phase shift information;
receiving, from the first device, a phase shift response message;
transmitting, to the UEs, a reference signal corresponding to the phase shift information; and
receiving, from the UEs, channel state information.

5. The method of claim 3, further comprising:
determining, as a reference UE, a UE having a smallest variance value of a channel gain based on the determined channel gain; and
allocating a smallest power to the reference UE.

6. The method of claim 5, wherein determining the power allocation coefficients comprises:
determining power allocation for UEs other than the reference UE such that a UE having a smaller channel gain is allocated greater power.

7. The method of claim 6, wherein determining the power allocation coefficients further comprises:
allocating, to the UE, based on a minimum Signal-to-Interference-Noise Ratio (SINR) for decoding; and
additionally allocating, to the UE, remaining power after allocating power to the UEs in proportion to an inverse of a channel gain.

8. The method of claim 4, wherein the communication channel is determined as a channel having a largest sum of the channel gain measured for each channel.

9. The method of claim 8, wherein the channel reselection object includes at least one of a threshold for channel reselection or a channel gain of a channel not using the RIS.

10. The method of claim 9, wherein a signal for a UE having a channel gain lower than a predetermined reference value than a channel gain of a reference UE is excluded from superposition coding.

11. The method of claim 1, wherein establishing the RRC connection comprises:
receiving, from the first device, an RRC setup request message;
transmitting, to the first device, an RRC setup message;
receiving, from the first device, an RRC setup complete message;
transmitting, to the first device, a capability enquiry message;
receiving, from the first device, a capability information message; and
transmitting an RRC reconfiguration message,
wherein the RRC setup request message includes information representing whether it is requested by the RIS,
the RRC setup complete message includes information representing that a connection with the RIS has been established, and
the capability enquiry message includes the reflection pattern information.

12. The method of claim 11, further comprising:
determining an RIS user group based on the plurality of channel state information;
transmitting a channel reselection object to the UEs; and
receiving a channel reselection request from a UE belonging to the RIS user group.

13. A method, comprising:
receiving, by a user equipment (UE) from a base station, a reference signal;
transmitting by the UE, channel state information based on the reference signal;
receiving, by the UE from the base station, a channel reselection object;
transmitting, by the UE, a channel reselection request message based on the channel reselection object; and
receiving, by the UE, a signal generated by superposition coding from the base station through a reconfigurable intelligent surface (RIS) channel,
wherein the channel reselection object includes at least one of a threshold for channel reselection or a channel gain of a channel not using an RIS.

14. The method of claim 13, wherein the channel reselection request message is transmitted if a channel gain is measured to be smaller than a predetermined reference value than a threshold for the channel reselection, or measured to be smaller than a channel gain of a channel not using the RIS.

15. The method of claim 14, wherein a signal for the UE is extracted from the received signal by using a successive interference cancellation.

16. A base station, comprising:
at least one transceiver;
at least one processor; and
at least one memory connected to the at least one processor and storing instructions that, based on being executed, cause the based station to perform operations comprising:
establishing a radio resource control (RRC) connection with a first device;
receiving a plurality of channel state information based on the RRC connection;
determining a communication channel based on the plurality of measured channel state information;
determining power allocation coefficients of user equipments (UEs) based on the communication channel; and
transmitting a signal based on the power allocation coefficients,
wherein establishing the RRC connection comprises: receiving reflection pattern information that is changeable through reconfigurable intelligent surface (RIS) control by the first device, and
wherein the signal is transmitted, after being generated by superposition coding, to the UEs through an RIS channel.

17. (canceled)

18. (canceled)

19. (canceled)
